(19) United States
(12) Patent Application Publication
(10) Pub. No.: US 2023/0355027 A1
(43) Pub. Date: Nov. 9, 2023

(54) COFFEE DRIP BAG

(71) Applicant: COFFEE N DO CO., LTD., Gwangju-si (KR)

(72) Inventors: Eui Sun LEE, Yongin-si (KR); Jung Young LEE, Yongin-si (KR)

(21) Appl. No.: 17/790,567

(22) PCT Filed: Sep. 17, 2021
(86) PCT No.: PCT/KR2021/012758

§ 371 Date: Jul. 1, 2022

(30) Foreign Application Priority Data
Sep. 21, 2020 (KR) 10-2020-0121255
Sep. 13, 2021 (KR) 10-2021-0121850

(51) Int. Cl. A47J 31/02; B65D 85/804; A47J 31/06

(52) U.S. Cl. CPC A47J 31/0626; A47J 31/02; B65D 85/8061

(57) ABSTRACT

The present disclosure discloses a coffee drip bag comprising: a filter portion that accommodates coffee while an upper portion is open; a latching portion formed in the center with an opening portion through which hot water flows in, engaging and fixing the filter portion along a periphery of the opening portion and being mounted on an upper end portion of the coffee cup while a first latching member and a second latching member press the upper and lower surfaces of the upper region of the filter portion, and a lid portion that engages on an upper surface of the latching portion while shielding the opening portion, wherein the lid portion is coated with a resin layer on a lower surface of the lid portion or an upper surface of the latching portion and is coupled to the upper surface of the latching portion by thermal bonding.

### TECHNICAL FIELD

The present disclosure relates to a coffee drip bag.

### BACKGROUND ART

Currently, coffee is a favorite food used by many people from young people to older people, and there are various kinds of coffee such as instant coffee like mixed coffee and bean coffee using coffee beans.

Among them, they prefer coffee made by grinding coffee beans directly in terms of flavor and luxury as well as its taste and aroma.

However, instant coffee may be enjoyed simply by pouring disposable coffee into a cup and mixing it with only hot water, as most of the disposable coffee bags are placed in the office or at home, or may be carried regardless of the place, while bean coffee is made by mixing the undiluted solution of coffee extracted using a coffee bean extractor with an appropriate amount of water, which is not easy for the general public to use because the work to extract the undiluted solution of coffee beans is cumbersome and such coffee beans extractors are quite expensive.

In order to solve this matter, the applicant has developed and proposed a coffee drip bag in Korean Patent Application Publication No. 10-2016-0085565 (prior art). The coffee drip bag in the prior art has the effect that the drinker may easily and conveniently drink high-quality bean coffee with a simple configuration.

However, the coffee drip bag in the prior art has a configuration in which the latching design portion and the lid are connected via a perforated line, and there is a difficulty in the process of forming a separate perforated line between them. In addition, since the coffee drip bag in the prior art has to form a handle separately on the lid, the manufacturing process of the lid is complicated and has limitations in designing the lid in various ways.

### DISCLOSURE

### Technical Problem

The present disclosure was proposed to solve the above matters, and an aspect of the present disclosure is to provide a coffee drip bag that is easy to manufacture while improving user convenience.

Also, an aspect of the present disclosure is to provide a coffee drip bag that may be modified or applied in a more diverse manner in the process of manufacturing.

Also, an aspect of the present disclosure is to provide a coffee drip bag with good environmental affinity using an environmentally friendly material.

### Technical Solution

A coffee drip bag according to an example embodiment of the present disclosure for solving the above-described matter includes a filter portion that accommodates coffee while an upper portion is opened, a latching portion formed in the center with an opening portion through which hot water flows in, engaging and fixing the filter portion along a periphery of the opening portion and being mounted on an upper end portion of the coffee cup, and a lid portion that engages on an upper surface of the latching portion while shielding the opening portion, in which the lid portion is coated with a resin layer on a lower surface of the lid portion or an upper surface of the latching portion and is coupled to the upper surface of the latching portion by thermal bonding.

Further, the lid portion may be coupled to the latching portion while forming a bonding line around the opening portion.

The lid portion or the latching portion may also include a cutting line formed along a side of the bonding line.

Further, the lid portion may form a perforated line in which multiple holes are formed discontinuously and an incision portion in an inner region of the perforated line.

In addition, the perforated line may be formed such that the line is concave or convex to form a press portion on the inside or the outside.

And a coffee drip bag according to another example embodiment of the present disclosure for solving the above-described matter includes a filter portion for accommodating coffee while an upper portion is opened, a latching portion formed in the center with an opening portion through which hot water flows in, engaging and fixing the filter portion along a periphery of the opening portion and being mounted on an upper end portion of the coffee cup, and a lid portion having an latching flange contacted and engaged to an upper surface of the latching portion, a shielding plate for shielding the opening portion while making a step up and down from the latching flange, an end engaging groove formed in an outer peripheral surface while extending downward and outward from an inner end portion of the latching flange, and an end latching jaw connected to the shielding flange while extending further outward from the end engaging groove, the lid portion being engaged in the latching portion so that an opening region end portion of the latching portion is inserted into the end inserting groove.

Further, the lid portion may further include a plate inserting groove formed concavely in an inner surface of the end latching jaw, and a reinforcing plate formed in an image on a surface and coupled to the shield plate upper surface while an edge end is inserted into the plate inserting groove.

### Advantageous Effects

The coffee drip bag of the present example embodiment is harmless to the human body by using an eco-friendly paper material and can provide excellent environmental affinity.

In addition, the coffee drip bag of the present example embodiment can be designed variously into the shape of the lid portion or implemented with an image on the surface of the lid portion, and can be variously utilized for advertising or promotional purposes.

In addition, the coffee drip bag of the present example embodiment can be easily separated while the lid portion is stably engaged, thereby greatly improving the safety and convenience of use.

In addition, the coffee drip bag of the present example embodiment can have high durability with the folded portion of the filter portion having an overlapping structure.

### DESCRIPTION OF DRAWINGS

FIG. 1 is a perspective view of a coffee drip bag according to an example embodiment of the present disclosure.

FIG. 2 is a plan view of the drip bag of FIG. 1.

FIG. 3 is a cross-sectional view of the drip bag of FIG. 2 in an I-I direction.

FIG. 4 is a plan view of another example of a drip bag of FIG. 1.

FIG. 5 is a cross-sectional view of the drip bag of FIG. 4 in an II-II direction.

FIG. 6 is a perspective view of a coffee drip bag according to another example embodiment of the present disclosure.

FIG. 7 is a cross-sectional view of the drip bag of FIG. 6 in an III-III direction.

### MODE FOR INVENTION

The technical matters achieved by the present disclosure and the practice of the present disclosure will become apparent by the preferred example embodiments described below. Preferred example embodiments of the disclosure will now be discussed in detail with reference to the accompanying drawings.

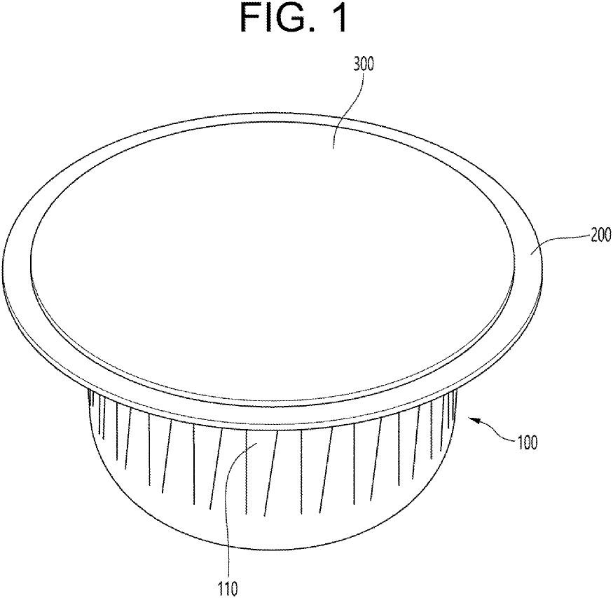

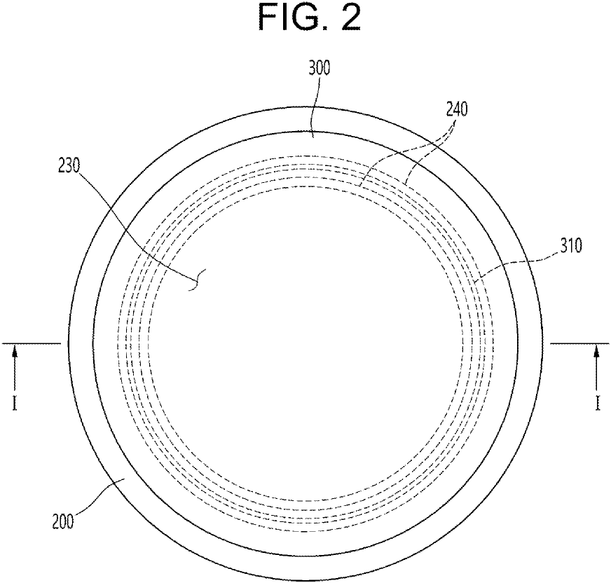

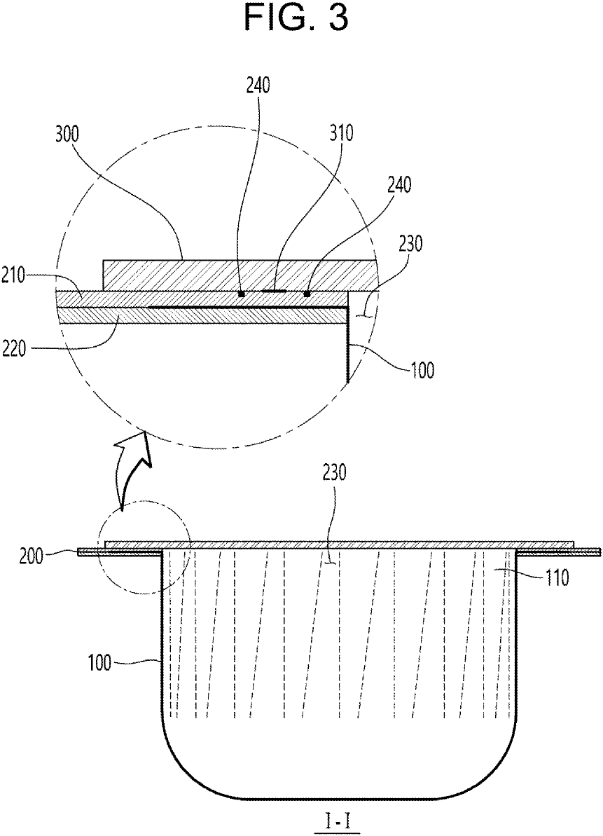

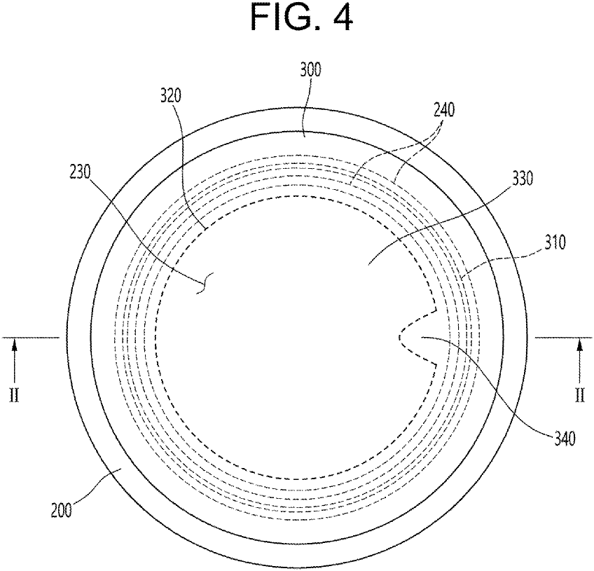

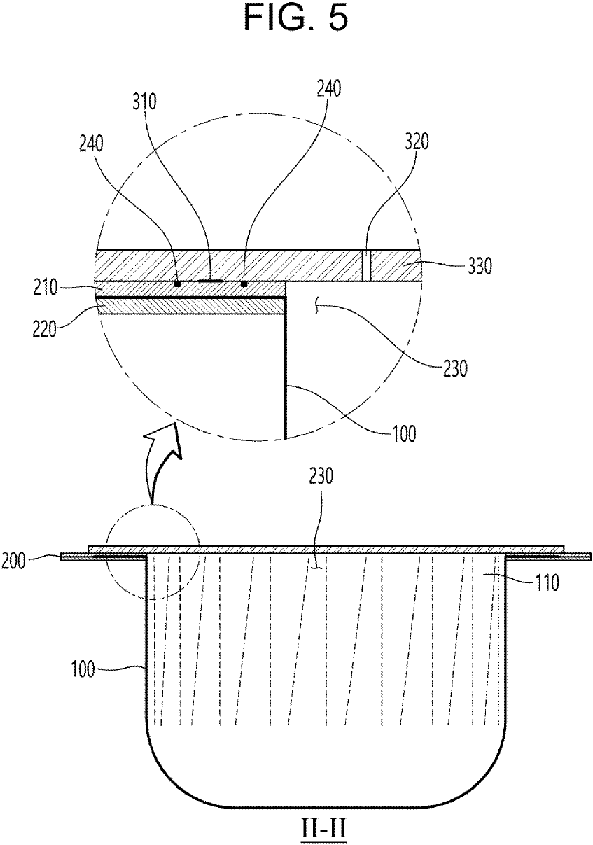

FIG. 1 is a perspective view of a coffee drip bag, FIG. 2 is a plan view of the drip bag of FIG. 1, FIG. 3 is a cross-sectional view of the drip bag of FIG. 2 in the I-I direction, FIG. 4 is a plan view of another example of a drip bag of FIG. 1, and FIG. 5 is a cross-sectional view of the drip bag of FIG. 4 in the II-II direction in accordance with an example embodiment of the present disclosure.

As shown in these figures, the coffee drip bag of the present example embodiment includes a filter portion 100, a latching portion 200 to which the filter portion is fixed, and a lid portion 300 to shield an opening portion of the latching portion.

The filter portion 100 has a pocket shape in which the top surface is opened so that the ground beans can be filled and received therein. The filter portion 100 drips hot water so that coffee can be filtered and flowed down to the bottom, and may be made of paper material that is harmless to the human body, and may have a mesh or porous structure.

The filter portion 100 is supported by the upper end coupled to the latching portion 200, and the portion abutting against the latching portion 200 forms the overlap region 110 by folding. The filter portion 100 is bonded to the latching portion 200 while the upper end portion is bent in the horizontal direction, and the portion in contact with the latching portion 200 is relatively degraded in durability due to the deformation that is bent, so that it can be easily broken or torn. However, the durability to the bent portion is improved when bent while forming the overlap region 110 as in the present example embodiment.

The latching portion 200 is configured to hang on the upper end of the coffee cup so that the coffee drip bag can be mounted on the coffee cup, and the filter portion 100 is engaged and fixed on the lower surface, and the lid portion 300 is engaged on the upper surface. The diameter of the latching portion 200 for this purpose is formed to be larger than the upper end diameter of the coffee cup so that the latching portion 200 can be latched and mounted on the upper end of the coffee cup. The latching portion 200 may be made of paperboard of an eco-friendly material.

Further, the latching portion 200 may generally have a circular shape corresponding to the opening shape of the coffee cup, and a circular opening portion 230 having a predetermined diameter is formed in the central portion. The latching portion 200 thus forms a circular flange shape having a predetermined width. The opening portion 230 communicates between the inside and the outside of the filter portion 100 so that the ground beans are filled and hot water can be dripped.

Further, the latching portion 200 couples the filter portion 100 along the edge of the opening portion 230 and causes the filter portion 100 to be located inside the coffee cup when mounted on the coffee cup. The latching portion 200 is made of a circular cardboard having an opening portion 230 formed in the center, and may include a first latching member 210 on the top and a second latching member 220 on the bottom so as to be able to couple the filter portion 100 to the center.

The first latching member 210 presses the upper surface of the filter portion 100, and the second latching member 220 presses the lower surface of the filter portion 100 so that the filter portion 100 is engaged therebetween. To this end, a polyethylene terephthalate (PET) coating layer may be applied to the lower surface of the first latching member 210 and the upper surface of the second latching member 220, and the filter portion 100 may be bonded by thermal fusion using a PET coating layer.

The lid portion 300 is coupled to the upper surface of the latching portion 200 while shielding the opening portion 230 of the latching portion 200. The lid portion 300 thus forms a plate shape having at least a larger diameter than the opening portion 230.

The lid portion 300 is composed of paperboard made of paper used for food and beverages, and can form a variety of shapes with a diameter larger than the opening portion 230 in shortest diameter. Although the circular lid portion 300 is illustrated in the present example embodiment, various shapes may be made such as a coffee bean shape, a star shape, a sunflower shape, a square shape, etc. Further, although not shown, an advertising design may be printed on the surface of the lid portion 300.

As such, the lid portion 300 of the present example embodiment can be manufactured in various shapes separately from the latching portion 200, and an image can be printed on the surface, so that the design of the coffee drip bag can be selected in more various ways. Further, the lid portion 300 can manufacture an eco-friendly coffee drip bag by using a paper material.

This lid portion 300 is bonded to the latching portion 200 by a thermal bonding process. To this end, the upper surface of the latching portion 200 or the lower surface of the lid portion 300 is coated with a resin layer harmless to the human body. The lid portion 300 is adhered to the latching portion 200 with instantaneous thermal adhesion applied along the periphery of the opening portion 230 while resting on top of the latching portion 200 to shield the opening portion 230. At this time, thermal bonding may be applied circularly along the periphery of the opening portion 230, and a circular bonding line 310 is formed. Thus, the lid portion 300 and the latching portion 200 are bonded along the bonding line 310 around the opening portion 230, and the bonding line 310 seals the filter portion 100 from the outside between the lid portion 300 and the latching portion 200. At this time, the bonding line 310 may be formed continuous or discontinuous.

Further, the lid portion 300 is further formed with a bonding spot (not shown) bonded to the latching portion 200 in an edge region outside the bonding line 310. The bonding spots are formed in a plurality at a predetermined spacing along a circumference in an edge region of the lid portion 300, and thermally bond the lid portion 300 and the latching portion 200 in a spot structure. The bonding spot prevents the end of the lid portion 300 from unfolding from the latching portion 200 due to external interference, and at the same time, keeps the non-adhesive state between neighboring bonding spots, so that the user can easily detach the lid portion 300.

In this way, the lid portion 300 of the present example embodiment is applied with the first bond of the line structure and the second bond of the spot structure, so that the lid portion 300 and the latching portion 200 can be easily separated while stable bonding is achieved, thereby improving ease of use.

Further, the coffee drip bag of the present example embodiment has a cutting line 240 formed on the side of the bonding line 310. The cutting line 240 may be formed by applying a half cutting to the surface of the latching portion 200. Further, the cutting lines 240 may be formed on the inner or outer sides of the bonding line 310 or both sides. In addition, the cutting line 240 may be formed with continuous or discontinuous application of half cutting. That is, the cutting line 240 may be a continuous line shape or a discontinuous dotted line shape.

This cutting line 240 blocks the phenomenon of the latching portion 200 or the surface of the lid portion 300 being torn by the bonding line 310 when the lid portion 300 is separated from the latching portion 200. The lid portion 300 and the latching portion 200 are made of eco-friendly paper material and are bonded along the bonding line 310. Thus, when the lid portion 300 and the latching portion 200 are separated, the surface of the latching portion 200 can be separated while being torn together by the adhesive force of the bonding line 310. However, in the case where the cutting line 240 is formed on the side of the bonding line 310 as in the present example embodiment, even if the surface of the latching portion 200 is torn, the phenomenon of tearing at the cutting line 240 is blocked to prevent irregular tearing.

Such a cutting line 240 has illustrated a configuration formed on a surface of the latching portion 200 (that is, a top surface of the latching portion), but may be formed on a surface of the lid portion (that is, a bottom surface of the lid portion) or both.

On the other hand, referring to FIGS. 4 and 5, the coffee drip bag of the present example embodiment forms an incision portion 330 in its inner region while a perforated line 320 is formed in the lid portion 300. The perforated line 320 is formed in the area of the opening portion 230 and serves to separate the incision portion 330 from the lid portion 300 along the perforated line 320 to open the filter portion 100.

The perforated line 320 may be formed by a number of holes through which the lid portion 300 is discontinuously penetrated. The perforated line 320 may have various shapes, such as a circular shape, a square shape, and the shape is not limited, and it would be desirable to have a shape corresponding to the shape of the opening portion 230. In addition, the perforated line 320 may have a closed circular shape or a rectangular shape, and may be configured to be formed only in some areas, such as a ‘c’ shape.

In addition, the perforated line 320 protrudes concavely or convexly in one side region, forming a press portion 340 on the inside or outside of the perforated line 320. The user can easily separate the entire incision portion 330 from the lid portion 300 by first pressing the press portion 340 to separate the incision portion 330 along the perforated line 320.

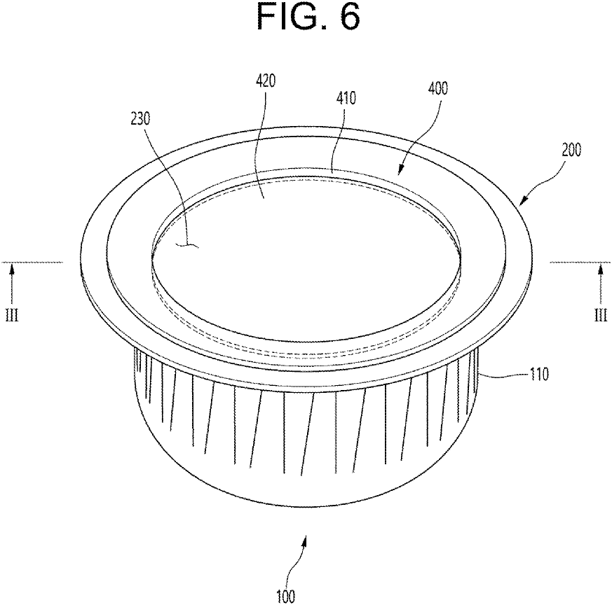

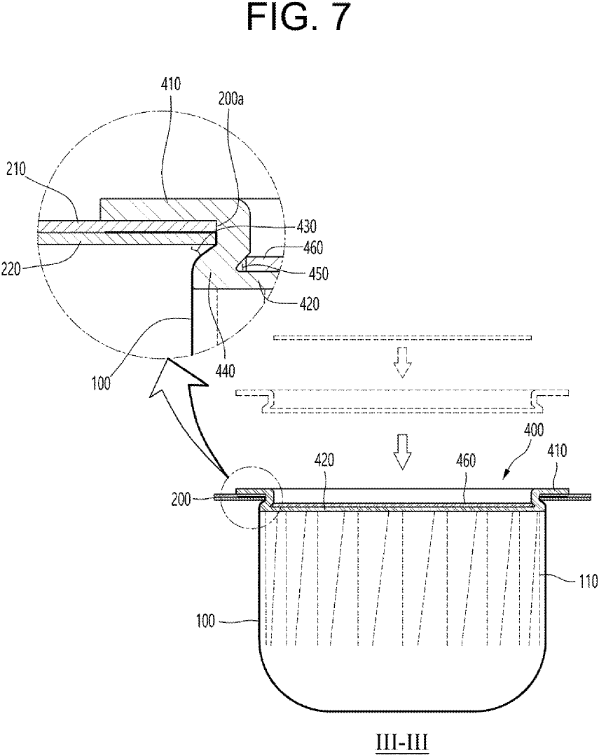

FIG. 6 is a perspective view of a coffee drip bag according to another example embodiment of the present disclosure, and FIG. 7 is a cross-sectional view of the drip bag of FIG. 6 in the III-III direction.

The drip bag of the present example embodiment is structured in such a way that the lid portion 400 is assembled along the opening portion 230 of the latching portion 200. For this purpose, the lid portion 400 is such that the latching flange 410 in the edge region and the shield plate 420 in the inner central region thereof are stepped up and down, and the upper and lower connection portions between the latching flange 410 and the shield plate 420 are stepped left and right while the end engaging groove 430 and the end latching jaw 440 are respectively formed in the outer upper and lower portions.

Specifically, the lid portion 400 is circularly formed along the end portion of the opening portion 230 region of the latching portion 200 with a latching flange 410 that abuts against the upper surface of the latching portion while forming a circular shape. That is, the latching flange 410 has a larger diameter than the opening portion 230 so that the lid portion 400 may be assembled while shielding the opening portion 230.

The end engagement groove 430 is formed along the outer side with the inner end of the latching flange 410 continuously extending downward and outward. The end engagement groove 430 is formed at a height corresponding to the thickness of the latching portion 200, and inserts the opening region end portion 200a of the latching portion 200.

Further, the inner end of the latching flange 410 is connected with the shield plate 420 while extending further outward to form the end latching jaw 440. That is, the end engagement groove 430 is formed between the latching flange 410 and the end latching jaw 440 while being spaced apart. The end latching jaw 440 supports the lower surface of the opening region end portion 200a of the latching portion 200.

Thus, the lid portion 400 may be assembled with the latching flange 410 and the end latching jaw 440 supporting the inner end top and bottom surface of the latching portion 200, respectively.

Further, the end latching jaw 440 is formed with a plate inserting groove 450 in a relatively concave shape on the inside while protruding outward. In the plate inserting groove 450, the edge end thereof is inserted and secured while the reinforcing plate 460 is seated on the top surface of the shield plate 420.

The reinforcing plate 460 is composed of a circular plate that reinforces the coupling force of the lid portion. The reinforcing plate 460 is inserted into the plate inserting groove 450 at the top surface of the shielding plate 420 and assembled to reinforce the engagement force of the lid portion 400. That is, the reinforcing plate 460 acts such that the edge end is inserted into the plate inserting groove 450 such that the end latching jaw 400 is forced outward. The reinforcing plate 460 thus allows the lid portion 400 not to be easily detached from the latching portion 200 and to securely maintain the engaged state, thereby improving the safety of use.

In addition, the reinforcing plate is a circular plate on which an image for the purpose of advertisement, product description, or the like is printed, and images of various shapes such as a logo, a figure, or a letter may be printed on the surface. Thus, the drip coffee bag of the present example embodiment may use the reinforcement plate 460 to select the design more diversely, and change the design by replacing only the reinforcement plate 460.

While exemplary example embodiments of the disclosure have been shown and described as described above, various modifications and other example embodiments may be made by those skilled in the art. These modifications and other example embodiments are all contemplated and included in the appended claims without departing from the true spirit and scope of the disclosure.

1. A coffee drip bag comprising:
a filter portion that accommodates coffee while an upper portion is opened;
a latching portion formed in the center with an opening portion through which hot water flows in, engaging and fixing the filter portion along a periphery of the opening portion and being mounted on an upper end portion of the coffee cup; and
a lid portion that engages on an upper surface of the latching portion while shielding the opening portion.

2. The coffee drip bag according to claim 1,
wherein the lid portion is coupled to the latching portion while forming a bonding line around the opening portion by thermal bonding.

3. The coffee drip bag according to claim 2,
wherein the lid portion or the latching portion comprises a cutting line formed along a side of the bonding line.

4. The coffee drip bag according to claim 3,
wherein the lid portion forms a perforated line in which multiple holes are formed discontinuously and an incision portion in an inner region of the perforate line.

5. The coffee drip bag according to claim 4,
wherein the perforated line is formed such that a line is concave or convex to form a press portion on an inner or outside.

6. The coffee drip bag according to claim 1,
wherein the lid portion includes a latching flange contacted and engaged to an upper surface of the latching portion, a shielding plate for shielding the opening portion while making a step up and down from the latching flange, an end engaging groove formed in an outer peripheral surface while extending downward and outward from an inner end portion of the latching flange, and an end latching jaw connected to the shielding flange while extending further outward from the end engaging groove, and
wherein the lid portion being engaged in the latching portion so that an opening region end portion of the latching portion is inserted into an end inserting groove.

7. The coffee drip bag according to claim 6,
wherein the lid portion further includes;
a plate inserting groove formed concavely in an inner surface of the end latching jaw, and
a reinforcing plate formed in an image on a surface and coupled to the upper surface of the shield plate while an edge end is inserted into the plate inserting groove.

8. The coffee drip bag according to claim 1,
the filter portion forms an overlap region by folding at a portion coupled to the latching portion.

9. The coffee drip bag according to claim 2,
the filter portion forms an overlap region by folding at a portion coupled to the latching portion.

10. The coffee drip bag according to claim 6,
the filter portion forms an overlap region by folding at a portion coupled to the latching portion.
